(19) United States
(12) Patent Application Publication
(10) Pub. No.: US 2004/0036654 A1
(43) Pub. Date: Feb. 26, 2004

(54) Antenna assembly for circuit board

(76) Inventor: Steve Hsieh, Hsin Chuang City (TW)

Correspondence Address: Steve Hsieh, P.O. Box 4-67, Hsin Chuang, Taipei, 242, TW

(21) Appl. No.: 10/226,689

(22) Filed: Aug. 21, 2002

(51) Int. Cl. H01Q 1/24

(52) U.S. Cl. 343/702

(57) ABSTRACT

An antenna assembly includes a base member, an antenna device having an antenna member disposed on one surface of the base member, a ground member disposed on the opposite surface of the base member, and a conductive coupling member coupled between the antenna member and the ground member. The antenna device may include an additional antenna member coupled to the conductive coupling member and symmetric to the antenna member. An additional antenna device may be attached to the base member and parallel to or perpendicular to the antenna device for facilitating the antenna device.

### BACKGROUND OF THE INVENTION

1. Field of the Invention

The present invention relates to an antenna assembly, and more particularly to an antenna assembly for circuit boards.

2. Description of the Prior Art

Typical antenna devices may be provided or attached onto the circuit boards or the other dielectric materials. One example of the typical antenna devices is disclosed in U.S. Pat. No. 5,021,795 to Masiulis, and comprises a number of antenna members disposed on one side of the circuit boards only. The antenna device may receive signals from short distances only.

The present invention has arisen to mitigate and/or obviate the afore-described disadvantages of the conventional antenna devices.

### SUMMARY OF THE INVENTION

The primary objective of the present invention is to provide an antenna assembly for attaching onto circuit boards and for increasing the signal emitting or receiving distance or range.

The other objective of the present invention is to provide an antenna assembly including one or more antenna devices attached onto such as the printed circuit boards for increasing the signal emitting or receiving distance or range.

The further objective of the present invention is to provide an antenna assembly including one or more antenna devices and grounds attached onto both sides of the circuit boards, for increasing the signal emitting or receiving distance or range.

In accordance with one aspect of the invention, there is provided an antenna assembly comprising a base member including a first orifice formed therein, and including a first surface and an opposite second surface, and a first antenna device including a first antenna member provided on the first surface of the base member, a first ground member provided on the second surface of the base member, and a first conductive coupling member received in the first orifice of the base member and coupled between the first antenna member and the first ground member.

The first antenna member of the first antenna device includes a peripheral portion and a first end coupled to the first conductive coupling member, and a second end arranged within the peripheral portion of the first antenna member.

The first antenna device further includes another antenna member coupled to the first conductive coupling member, and preferably symmetric to the first antenna member and also includes a peripheral portion and a first end coupled to the first conductive coupling member, and a second end arranged within the peripheral portion of the another antenna member.

A second antenna device may further be provided and includes a second antenna member provided on the first surface of the base member, a second ground member provided on the second surface of the base member, and a second conductive coupling member received in the base member and coupled between the second antenna member and the second ground member.

The second antenna member of the second antenna device includes a peripheral portion and a first end coupled to the second conductive coupling member, and a second end arranged within the peripheral portion of the second antenna member.

The second antenna device may be arranged parallel to or perpendicular to the first antenna device for facilitating the first antenna device.

A third ground member may further be provided on the second surface of the base member and coupled to second ground member of the second antenna device.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is an upper plan view of an antenna assembly in accordance with the present invention;

FIG. 2 is a bottom plan view of the antenna assembly;

FIG. 3 is a partial upper plan view illustrating the operation of the antenna assembly;

FIG. 4 is a partial cross sectional view taken along lines 4-4 of FIG. 3;

FIG. 5 is another partial upper plan view illustrating the operation of the antenna assembly; and

FIGS. 6 and 7 are diagrams illustrating the operation or the testing of the antenna assembly.

### DETAILED DESCRIPTION OF THE PREFERRED EMBODIMENT

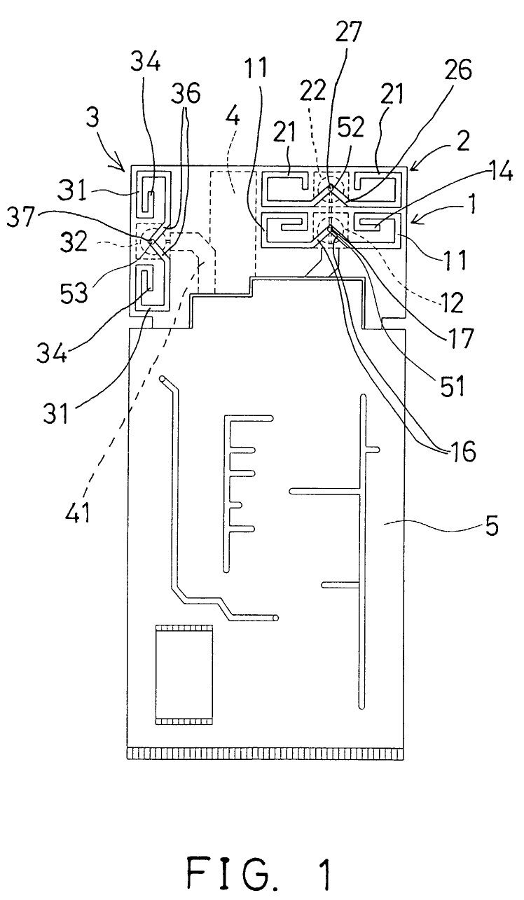

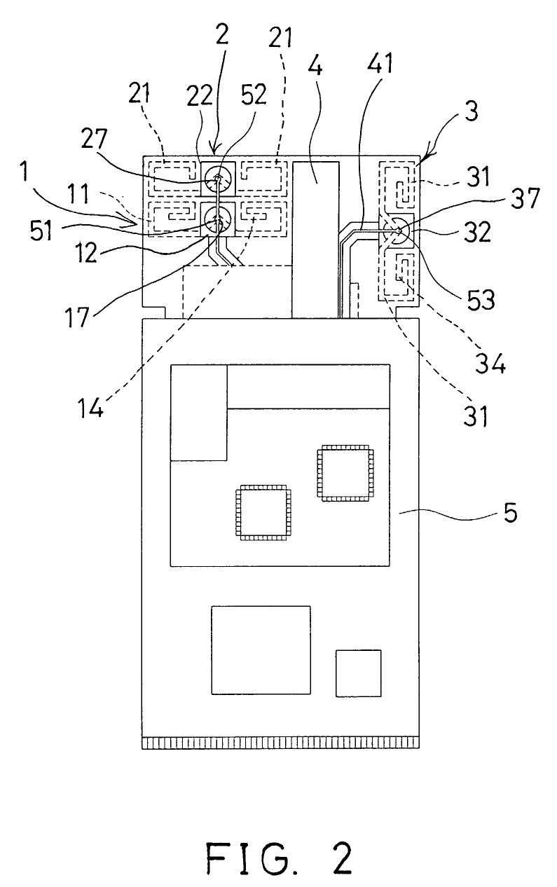

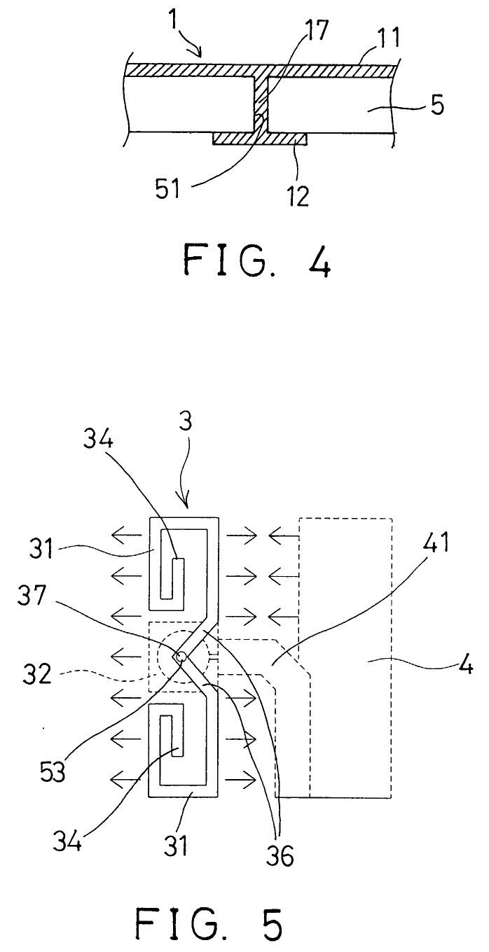

Referring to the drawings, and initially to FIGS. 1-4, an antenna assembly in accordance with the present invention comprises an insulating or dielectric base member 5, such as a circuit board, and particularly a printed circuit board, which includes one or more orifices 51, 52, 53 formed therein for receiving conductive coupling members 17 (FIG. 4).

An antenna device 1 includes one or more, such as two antenna members 11 provided or applied on one surface, such as the upper surface of the base member 5, and a ground member 12 provided or applied on the other surface, such as the lower surface of the base member 5, by such as the printed circuit board formation processes.

The antenna members 11 are preferably mirror symmetric with each other, and each includes a rectangular peripheral shape or portion, and one end 14 extended or provided within the rectangular peripheral portion thereof, and the other end 16 extended toward one of the orifices 51 of the base member 5, and coupled to the conductive coupling member 17 (FIG. 4), which may electrically couple the antenna members 11 and the ground member 12 together.

Another antenna device 2 may further be provided and may include one or more, such as two antenna members 21 provided or applied on such as the upper surface of the base member 5, and a ground member 22 provided or applied on such as the lower surface of the base member 5, by such as the printed circuit board formation processes.

The antenna members 21 are also preferably mirror symmetric with each other, and each includes a rectangular peripheral shape or portion, and one end 26 extended toward another orifice 52 of the base member 5, and coupled to a conductive coupling member 27 which is engaged in the orifice 52 of the base member 5 and which may also electrically couple the antenna members 21 and the ground member 22 together.

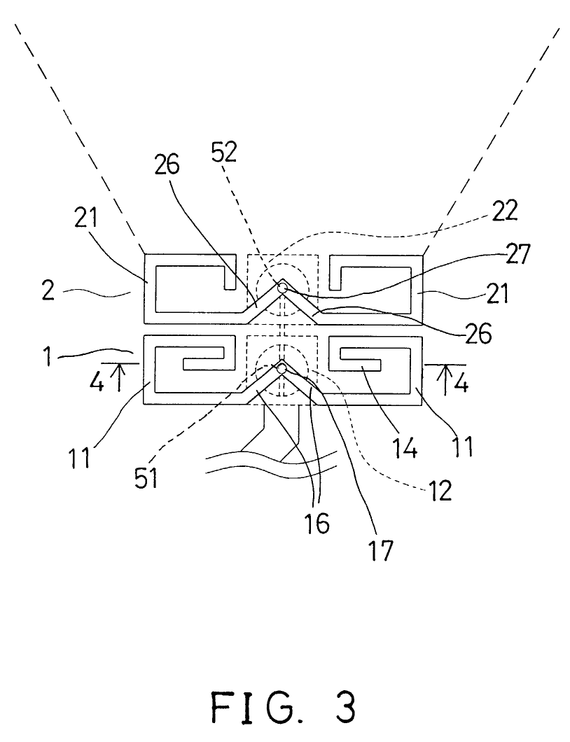

As best shown in FIG. 3, the antenna devices 1, 2 are preferably disposed and arranged laterally relative to the base member 5, or perpendicular or inclined relative to the longitudinal direction of the base member 5. The antenna device 2 is provided and arranged close to and parallel to the antenna device 1 for facilitating the antenna device 1, or for increasing the signal emitting or receiving distances or ranges of the antenna device 1.

The antenna assembly may further includes a further antenna device 3 having one or more, such as two antenna members 31 provided or applied on such as the upper surface of the base member 5, and a ground member 32 provided or applied on such as the lower surface of the base member 5, by such as the printed circuit board formation processes.

The antenna members 31 are also preferably mirror symmetric with each other, and each includes a rectangular peripheral shape or portion, and one end 34 extended or provided within the rectangular peripheral portion thereof, and the other end 36 extended toward a further orifice 53 of the base member 5.

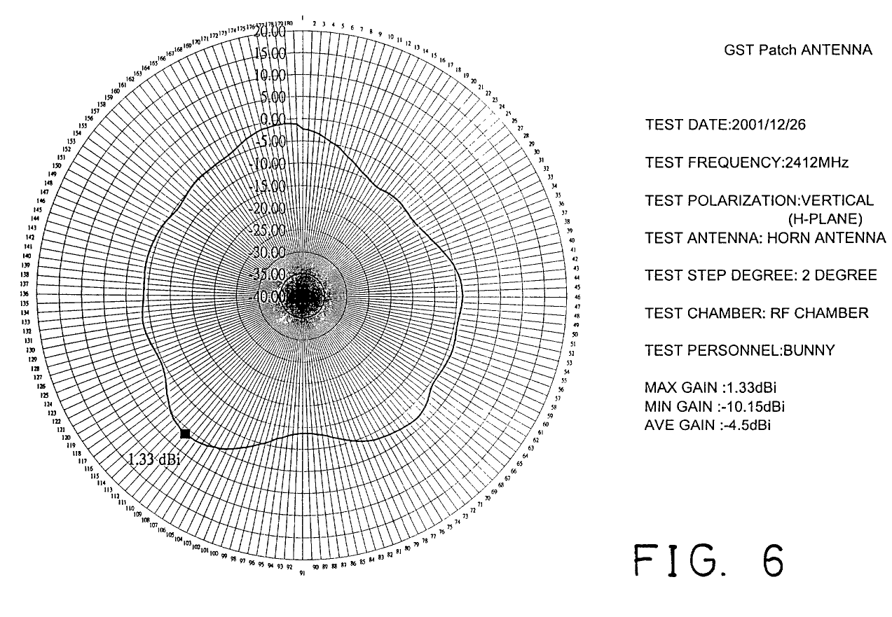

The other ends 36 of the antenna members 31 may be coupled to a conductive coupling member 37 which is engaged in the orifice 53 of the base member 5 and which may also electrically couple the antenna members 31 and the ground member 32 together. A further conductive or ground member 4 may further be provided and disposed or coupled to the ground member 32 of the antenna device 3 with such as a conductive element 41 (FIG. 5).

The antenna device 3 is preferably disposed and arranged parallel to the longitudinal direction of the base member 5, or perpendicular or inclined relative to the antenna devices 1, 2, and may be used for emitting or receiving signals from the other directions different from that of the antenna devices 1, 2, such that the antenna assembly may emit and receive signals from different angles or directions.

As shown in FIG. 5, the ground member 4 is preferably disposed close to the antenna device 3, for reflecting the signals emitted from the antenna device 3, and thus for increasing the signal emitting strength of the antenna device 3. For example, the signal generated by the antenna device 3 may be emitted for a further distance.

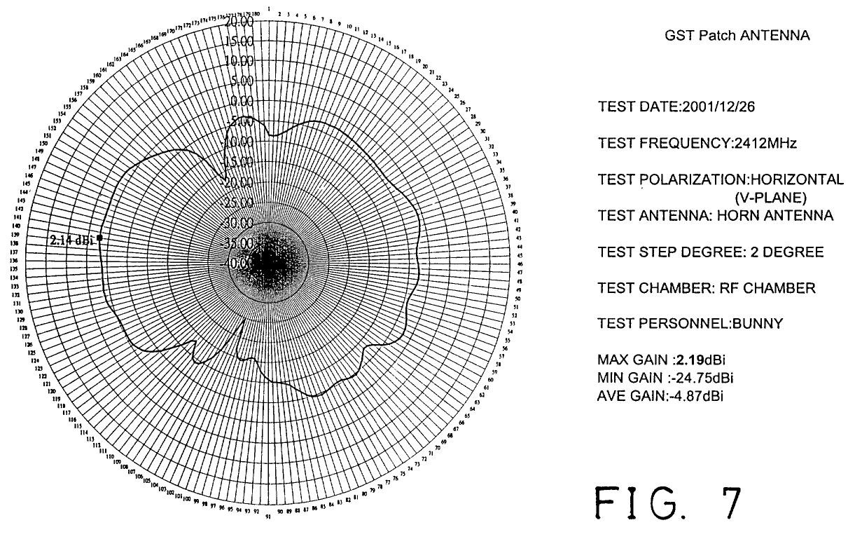

Referring next to FIG. 6, illustrated is a test conducted on Dec. 26, 2001, for a horn antenna member with a test frequency 2412 MHz, and with a vertical test polarization (H-plane), and with 2 degrees of test step degree, in a radio frequency (RF) chamber, and by Bunny. In the test, the maximum gain is 1.33 dBi, the minimum gain is −10.15 dBi, and the average gain is −4.5 dBi.

Referring next to FIG. 7, illustrated is a similar test conducted on Dec. 26, 2001, for the horn antenna member with a test frequency 2412 MHz, and with a horizontal test polarization (V-plane), and with 2 degrees of test step degree, in a RF chamber, and also by Bunny. In the test, the maximum gain is 2.19 dBi, the minimum gain is −24.75 dBi, and the average gain is −4.87 dBi.

Accordingly, the antenna assembly in accordance with the present invention includes one or more antenna devices for attaching onto circuit boards, such as for attaching onto the printed circuit boards for increasing the signal emitting or receiving distance or range. The antenna devices and grounds may be attached onto both sides of the circuit boards.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An antenna assembly comprising:
a base member including a first orifice formed therein, and including a first surface and an opposite second surface, and
a first antenna device including a first antenna member provided on said first surface of said base member, a first ground member provided on said second surface of said base member, and a first conductive coupling member received in said first orifice of said base member and coupled between said first antenna member and said first ground member.

2. The antenna assembly according to claim 1, wherein said first antenna member of said first antenna device includes a peripheral portion and a first end coupled to said first conductive coupling member.

3. The antenna assembly according to claim 2, wherein said first antenna member of said first antenna device includes a second end arranged within said peripheral portion of said first antenna member.

4. The antenna assembly according to claim 1, wherein said first antenna device further includes a second antenna member coupled to said first conductive coupling member.

5. The antenna assembly according to claim 4, wherein said second antenna member of said first antenna device includes a peripheral portion and a first end coupled to said first conductive coupling member.

6. The antenna assembly according to claim 5, wherein said second antenna member of said first antenna device is symmetric to said first antenna member and includes a second end arranged within said peripheral portion of said second antenna member.

7. The antenna assembly according to claim 1 further comprising a second antenna device including a second antenna member provided on said first surface of said base member, a second ground member provided on said second surface of said base member, and a second conductive coupling member received in said base member and coupled between said second antenna member and said second ground member.

8. The antenna assembly according to claim 7, wherein said second antenna member of said second antenna device includes a peripheral portion and a first end coupled to said second conductive coupling member.

9. The antenna assembly according to claim 8, wherein said second antenna member of said second antenna device includes a second end arranged within said peripheral portion of said second antenna member.

10. The antenna assembly according to claim 7, wherein said second antenna device is parallel to said first antenna device and further includes a third antenna member coupled to said second conductive coupling member.

11. The antenna assembly according to claim 10, wherein said third antenna member of said second antenna device includes a peripheral portion and a first end coupled to said second conductive coupling member.

12. The antenna assembly according to claim 7 further comprising a third ground member provided on said second surface of said base member and coupled to second ground member of said second antenna device.

13. The antenna assembly according to claim 7, wherein said second antenna device is perpendicular to said first antenna device, and further includes a third antenna member coupled to said second conductive coupling member.

14. The antenna assembly according to claim 13, wherein said third antenna member of said second antenna device is symmetric to said second antenna member, and includes a peripheral portion and a first end coupled to said second conductive coupling member, and includes a second end arranged within said peripheral portion of said third antenna member.
